(19) United States
(12) Patent Application Publication
(10) Pub. No.: US 2004/0179375 A1
(43) Pub. Date: Sep. 16, 2004

(54) Decorative apparatus with multi-layer lighting plates

(76) Inventor: Ching-Huai Chen, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/384,582

(22) Filed: Mar. 11, 2003

(51) Int. Cl. F21S 4/00

(52) U.S. Cl. 362/565

(57) ABSTRACT

The present invention relates to a decorative apparatus with multi-layer of lighting plates, which includes a first plate having a designed shape and being not transparent and a second plate having a reflecting surface. Several bulbs are provided between the two plates. By use of the light of the bulb, the decorative effect is novel and unique while the reflecting light showing the special figure of the first plate.

### BACKGROUND OF THE INVENTION

It is popular that a conventional decorative plate is mounted with many bulbs to display a special figure. The figure is formed by arrangement of the bulbs on the single plate or frame and the decorative effect is obtained as the bulbs are lightened. The outcome of the conventional single lighting plate is monotonous.

Accordingly, the present invention mainly provides an improved decorative apparatus, which includes several layers of plates mounted with bulbs to display a various decorative effect by use of the reflection of the lights.

### BRIEF DESCRIPTION OF THE DRAWINGS

Now the features and advantages of the present invention will be describes in detail with reference to the accompanying drawings.

FIG. 1 shows a perspective view of a decorative apparatus with two layers of lighting plates according to the present invention.

FIG. 2 shows a plan view of FIG. 1.

FIG. 3 shows an exploded view of FIG. 1.

FIG. 4 shows an exploded view of FIG. 2.

FIG. 5 shows a perspective view of a modified decorative apparatus with three layers of lighting plates according the present invention.

FIG. 6 shows a plan view of FIG. 5.

### DETAILED DESCRIPTION OF THE INVENTION

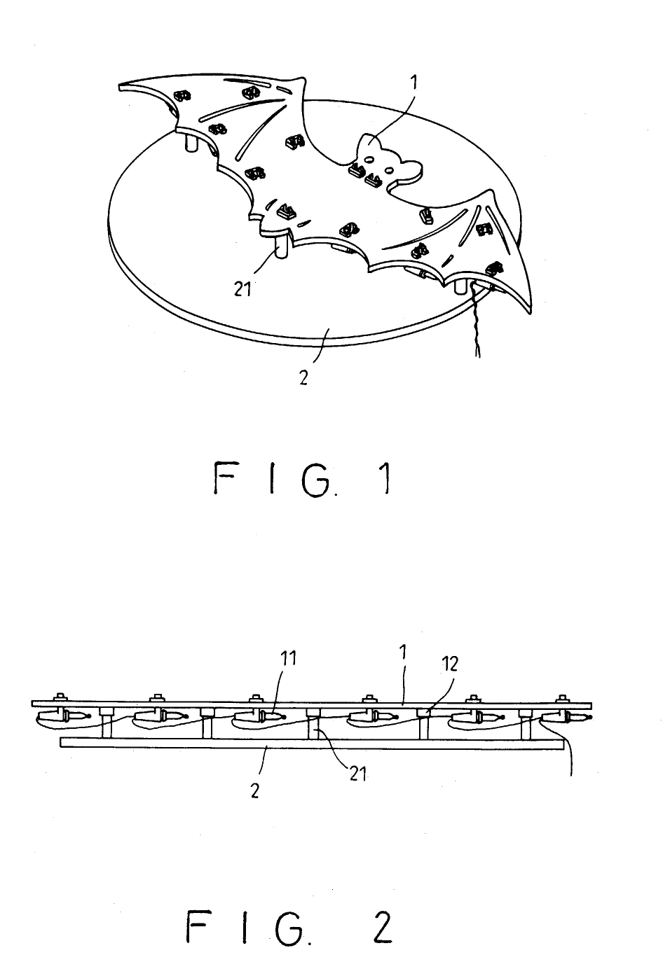

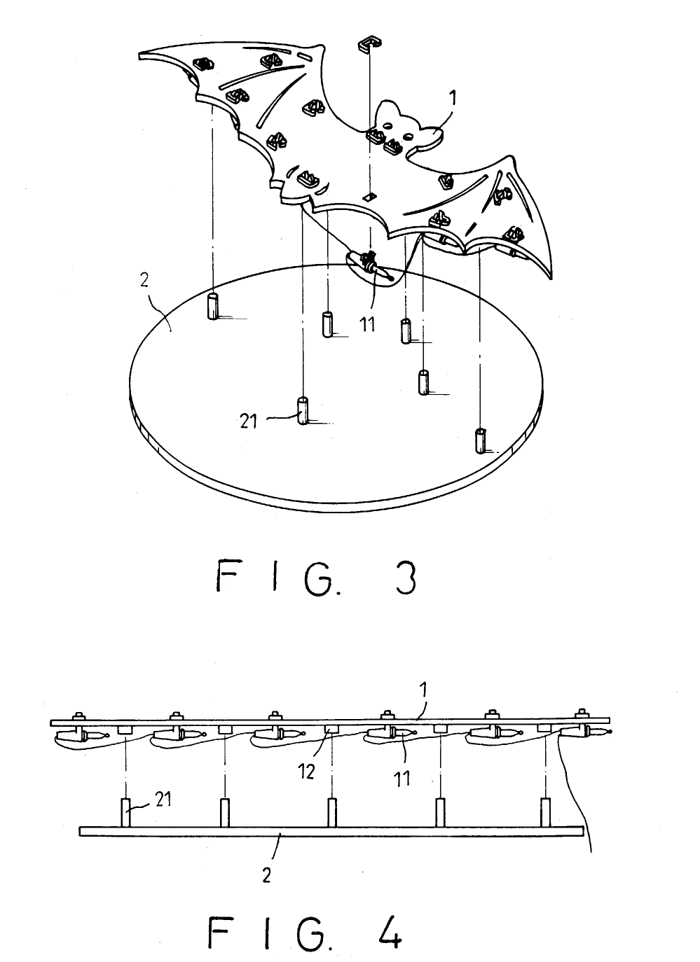

The present invention relates to a decorative apparatus with multi-layer of lighting plates. In the following embodiment, a decorative apparatus with two layers of lighting plates will be described for example. Please referring to FIG. 1 to 4, the apparatus of the present invention includes a first plate (1) and a second plate (2). The first plate (1) is not transparent and can be designed to have a special decorative shape. The first plate (1) has connected with several bulbs (1) and several receivers (12) at the bottom side. The second plate (2) has a reflecting surface and connects with several rods (21), each of which is related to the receiver (12) under the first plate (1) for engagement of the two plates.

In use, the bulb (11) emits the light on the second plate (2) while the light will be reflected and the reflected light will display the shape of the first plate (1) because the first plate (1) is not transparent. The outcome is the decorative figure of the first plate (1) floating on the shining second plate (2) that obtains a novel and unique decorative effect.

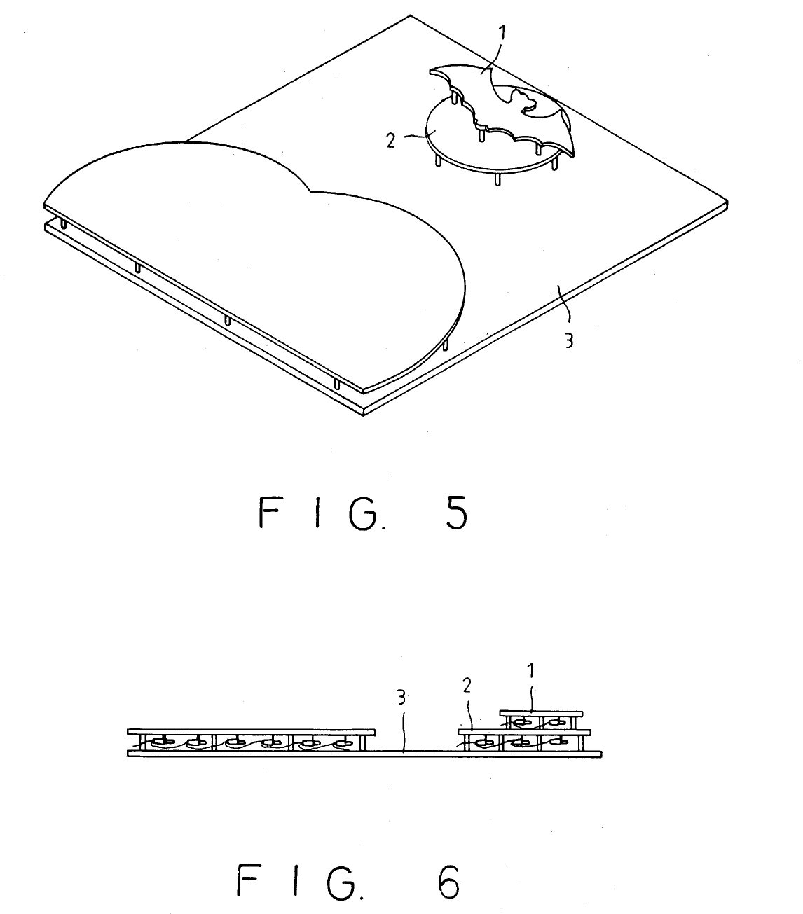

Based on the same technique, FIGS. 5 and 6 show another embodiment of the present invention, which includes a third lighting plate (3) under the second plate (2) while several bulbs (11) are provided between the second plate (2) and the third plate (3). It will be understood that a fourth plate or more plates can be connected to form the apparatus of the present invention.

What is claimed is:

1. A decorative apparatus with multi-layer of lighting plates including at least two plates, wherein a first plate is not transparent and connects with several bulbs and several receivers at bottom side, and a second plate has a reflecting surface and connects with several rods, each of which can be engaged with a relating receiver under the first plate to connect both plates together.

2. The decorative apparatus with multi-layer of lighting plates as claimed in claim 1, wherein the first plate can be designed to have any special shape.

3. The decorative apparatus with multi-layer of lighting plates as claimed in claim 1, wherein the shape of the first plate can be completed display by the reflection of the second plate.

4. The decorative apparatus with multi-layer of lighting plates as claimed in claim 1, wherein the apparatus includes three or more lighting plates.
